(19) United States
(12) Patent Application Publication
(10) Pub. No.: US 2007/0215289 A1
(43) Pub. Date: Sep. 20, 2007

(54) TAPER TOOL ASSEMBLY

(75) Inventor: C. Richard Kennedy, Woodstock, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: TEXAR CORPORATION, Kennesaw, GA (US)

(21) Appl. No.: 11/687,297

(22) Filed: Mar. 16, 2007

Related U.S. Application Data
(60) Provisional application No. 60/783,080, filed on Mar. 16, 2006.

(51) Int. Cl. B44C 7/00

(52) U.S. Cl. 156/577; 156/575

(57) ABSTRACT

In one embodiment, a taper tool assembly includes a body, a control sleeve, and at least one bearing surface. The body is configured to hold dry wall compound. The control sleeve is configured to move along at least a portion of a length of the body. The at least one bearing surface is positioned between the body and the control sleeve, the at least one bearing surface reducing friction between the body and the control sleeve.

### CROSS-REFERENCE TO RELATED APPLICATIONS

This application claims priority to co-pending U.S. provisional application entitled “Taper Tool,” filed Mar. 16, 2006 and accorded U.S. Ser. No. 60/783,080, which is incorporated herein by reference in its entirety.

### TECHNICAL FIELD

The present disclosure generally relates to a taper tool assembly for finishing dry wall, and more particularly relates to a control sleeve for such a taper tool assembly.

### BACKGROUND

Dry wall is type of wall finishing system that can be used to create relatively smooth interior walls in buildings. The walls are formed from studs that create a skeleton or frame for the building, and the dry wall, which comes in individual sheets, is attached to the studs, for example by screws or nails. Where the edges of two dry wall sheets meet along the studs, an exposed joint is formed that can be finished using dry wall tape and dry wall compound. More specifically, the dry wall compound is manually applied to the joint, and the dry wall tape is pressed against the compound, embedding the tape in the compound to cover the exposed joint. The joint is then finished by applying an additional layer of dry wall compound over the tape. This process is often referred to as “mudding and taping”.

In some cases, the joint finishing process is facilitated using a dry wall taper tool, such as the taper tool described in U.S. Pat. No. 2,815,142 to Ames, which is incorporated by reference in its entirety into the present disclosure. The taper tool embodiment described by Ames has an elongated body for holding the dry wall compound, a tape holder attached to the elongated body for holding a roll of dry wall tape, a head attached to one end of the elongated body for dispensing the dry wall tape, and a control sleeve slidably mounted on the elongated body for controlling operation of the head. In use, the head pulls the dry wall tape from the tape holder and applies dry wall compound to the tape from the body. The compound-laden tape is then rolled onto the joint using wheels on the head.

More specifically, the taper tool is controlled using a control sleeve coupled to the head. The control sleeve is a hollow cylinder of slightly larger circumference than the body, which encircles and is movable with respect to the body. For example, the control sleeve is reciprocated rearward (away from the head) to engage the head to cut the tape, and the control sleeve is reciprocated forward (toward the head) to engage the head to advance the tape.

To facilitate sliding the control sleeve over the body, the control sleeve typically has roller bearings positioned between the control sleeve and the body. In many cases, the control sleeve has flanges located at the forward and rearward ends of the control sleeve, and the roller bearings are housed in recessed in the flanges. One disadvantage of the roller bearings is that the roller bearings tend to wear against the body of the taper tool with normal operation. For example, grooves tend to form on the exterior surface of the body where the roller bearings contact the body as the control sleeve reciprocates forward and rearward. The wear problem is exacerbated by the texture of the dry wall compound, which tends to be abrasive. It is not uncommon for dry wall compound to collect on the exterior surface of the body and to become trapped between the exterior surface of the body and the roller bearings, abrading both the exterior surface of the body and the roller bearings. Additionally, the flanges that house the roller bearings on the ends of the control sleeve may interfere with a user's hand and may make operating the taper tool uncomfortable. From the above, it is apparent that a need exists for a taper tool assembly having a control sleeve that causes relatively reduced wear on the body of the assembly.

### SUMMARY

The taper tool of the present disclosure is directed to the aforementioned need, among others. In one embodiment, a taper tool assembly includes a body, a control sleeve, and at least one bearing surface. The body is configured to hold dry wall compound. The control sleeve is configured to move along at least a portion of a length of the body. The at least one bearing surface is positioned between the body and the control sleeve, the at least one bearing surface reducing friction between the body and the control sleeve.

In one embodiment, a control sleeve is configured to be moved along a body of a taper tool to control a head of the taper tool. The control sleeve includes an interior surface shaped to complement an exterior surface of the body, the interior surface surrounding a portion of the body. The control sleeve also includes at least one bearing surface coupled to the interior surface of the control sleeve. The at least one bearing surface is configured to reduce friction between the interior surface of the control sleeve and the exterior surface of the body as the control sleeve moves along the body.

In one embodiment, a taper tool assembly includes an elongated body, a tape assembly, a head, a control sleeve, and at least one bearing surface. The body is configured to hold dry wall compound. The tape assembly is configured to hold a roll of dry wall tape. The head is configured to eject compound from the body onto tape supplied by the tape assembly. The control sleeve is configured to be moved forward and rearward to control the head. The at least one bearing surface is positioned between the body and the control sleeve, the bearing surface reducing friction between the body and the control sleeve.

In one embodiment, the tape assembly includes an L-shaped retaining bar, a tall member, a rotating spool, and a short member. The tall member has an aperture configured to releasably hold a first end of the L-shaped retaining bar. The rotating spool is configured to hold a roll of dry wall tape, the rotating spool having a groove that is configured to releasably hold an intermediate section of the L-shaped retaining bar. The short member has a well, a second end of the L-shaped retaining bar being positioned in the well, the second end being able to rotate within the well. The roll of tape can be coupled to the tape holding assembly by removing the first end from the aperture, removing the intermediate section from the groove, rotating the L-shaped retaining bar about the second end in the well, placing the roll of dry wall tape on the rotating spool, rotating the L-shaped retaining bar back into place, positioning the intermediate section in the groove, and positioning the first end in the aperture.

Other systems, devices, methods, features, and advantages of the disclosed taper tool assembly will be apparent or will become apparent to one with skill in the art upon examination of the following figures and detailed description. All such additional systems, devices, methods, features, and advantages are intended to be included within the description and are intended to be protected by the accompanying claims.

### BRIEF DESCRIPTION OF THE FIGURES

The present disclosure may be better understood with reference to the following figures. Matching reference numerals designate corresponding parts throughout the figures, and components in the figures are not necessarily to scale.

FIG. 1 is a perspective view of an embodiment of a taper tool assembly.

FIG. 2 is a partial perspective view of the taper tool assembly shown in FIG. 1, illustrating a head of the taper tool assembly.

FIG. 3 is a perspective view of an embodiment of a control sleeve of the taper tool assembly shown in FIG. 1.

FIG. 4 is a partial perspective view of the taper tool assembly shown FIG. 1, illustrating a tape holding assembly of the taper tool assembly.

### DETAILED DESCRIPTION

As described above, it may be desirable to provide a taper tool assembly having a control sleeve that causes relatively reduced wear on the body of the taper tool assembly. As described below, such a taper tool assembly can be provided by including at least one bearing surface between the control sleeve and the body of the taper tool assembly, the bearing surface reducing friction between the control sleeve and the body.

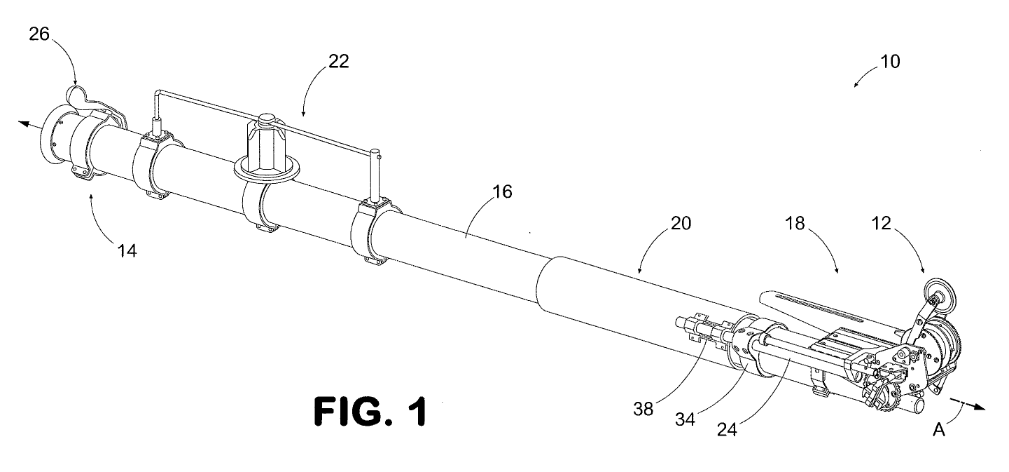

With reference to the Figures, FIG. 1 is a perspective view of an exemplary embodiment of a taper tool assembly 10. As shown, the taper tool assembly 10 has a body 16, a head 18, a control sleeve 20, a tape holding assembly 22, a control rod 24, and a trigger mechanism 26. The head 18 is coupled to a forward end 12 of the body 16, the tape holding assembly 22 is coupled to a rearward end 14 of the body 16, and the control sleeve 20 is positioned circumferentially around the body 16 between the head 18 and the tape holding assembly 22. The control rod 24 is positioned between the control sleeve 20 and the head 18 to operatively connect the control sleeve 20 to the head 18, and the trigger mechanism 26 is coupled to the body 16 rearward of the tape holding assembly 22. For the purposes of the present disclosure, the term “forward” means closer to the forward end 12 than to the rearward end 14 of the taper tool assembly 10, and the term “rearward” means closer to the rearward end 14 than to the forward end 12 of the taper tool assembly. Further, while a particular embodiment is described, a person of ordinary skill in the art would recognize that in other embodiments the components of the taper tool assembly 10 may be ordered along an axis A of the taper tool assembly 10 in any configuration. For example, in embodiments not shown, the tape holding assembly 22 may be positioned between the head 18 and the control sleeve 20, while the trigger mechanism 26 may be located anywhere along the axis A. In fact, in some embodiments, the trigger mechanism 26 may be omitted completely.

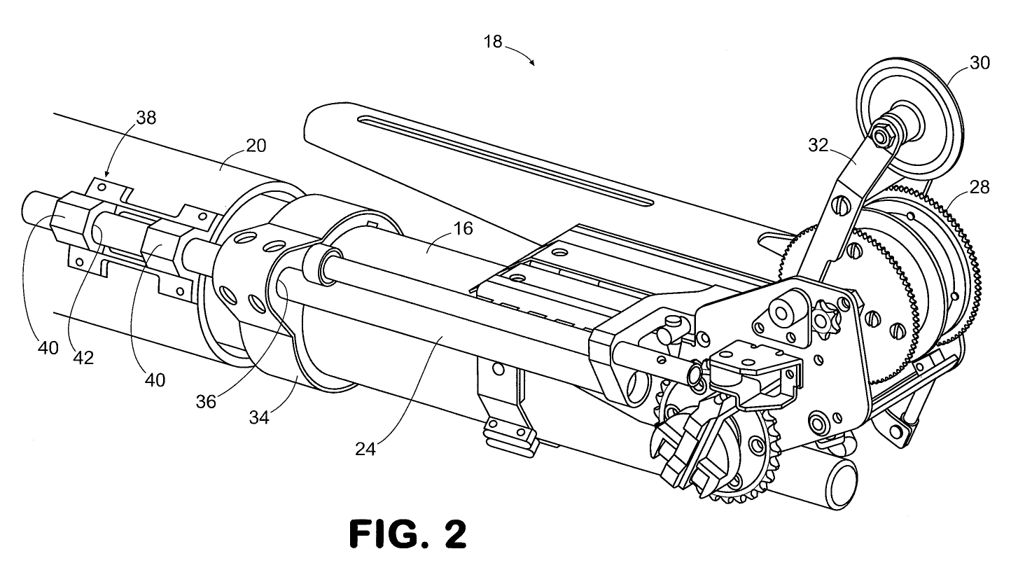

With reference to FIG. 1, the body 16 is configured to hold a substance such as dry wall compound in a hollow portion of the body 16, such as in an interior hollow within the body 16. As shown, the body 16 is a hollow elongated cylinder having an axis that is generally aligned with the axis A of the taper tool assembly 10, although in other embodiments the body 10 may have other shapes or configurations. The head 18 is configured to pull dry wall tape from the tape holding assembly 22, to apply dry wall compound to the dry wall tape, and to assist with applying the compound-laden tape to the exposed joint. An embodiment of the head 18 is shown in FIG. 2. The head 18 has an opening that can be used to fill the hollow portion of the body 16 with dry wall compound (not shown), and a nozzle configured to communicate the dry wall compound from the hollow portion of the body 16 (not shown). The head 18 may also be configured to remove air gaps from the body 16 after the dry wall compound has been loaded into the body 16 (not shown).

As shown, the head 18 has wheels 28, and in response to the rotation of the wheels 28, the head 18 is configured to simultaneously pull dry wall tape from the tape holding assembly 22 and to eject dry wall compound from the nozzle. In this manner, the dry wall tape is loaded with dry wall compound. The head 18 may also have a tape cutting mechanism configured to cut the tape (not shown) and a tape advancing mechanism configured to advance the tape forward (not shown). For example, the tape cutting mechanism may have a blade located rearward of the nozzle, and the tape advancing mechanism may have a pin. The pin engages the tape when the pin moves forward, and disengages the tape when the pin moves rearward. In some embodiments, the head 18 of the taper tool assembly 10 may be a conventional head such as a Model TT05 head, which is made by TapeTech of Duluth, Ga.

With reference back to FIG. 1, the control sleeve 20 is a hollow sleeve having an exterior surface that is configured to be comfortable for a user to grasp, and an interior surface that is configured to facilitate moving the control sleeve 20 along the body 16. The control sleeve 20 substantially surrounds a portion of the body 16 and is substantially aligned with the axis A of the body 16. The shape of the interior surface of the control sleeve 20 complements and is slightly circumferentially larger than the shape of the exterior surface of the body 16, and a length of the control sleeve 20 is also shorter than a length of the body 16. Thus, the control sleeve 20 is movable with respect to the body 16 between, for example, a forward position, a neutral position, and a rearward position.

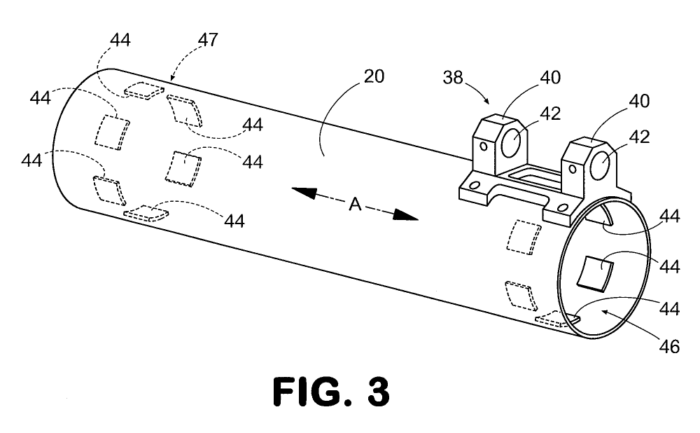

FIG. 3 is a perspective view of the embodiment of the control sleeve 20 shown in FIG. 1. As shown, the control sleeve 20 is a substantially a hollow cylinder having a cylindrical interior surface. The cylindrical interior surface complements the cylindrical exterior surface of the body 16, which is shown in FIG. 1. The control sleeve 20 encircles the body 16, and an inner radius of the control sleeve 20 is slightly larger than an exterior radius of the body 16 so that the control sleeve 20 is movable with respect to the body 16. While the body 16 and the control sleeve 20 are shown having circular or cylindrical cross-sections with the body 16 being nested inside the control sleeve 20, one skilled in the art would recognize that other cross-sectional shapes can be used. For example, the body 16 and the control sleeve 20 can have complementary square or elliptical cross-sections. In such embodiments, the shape of the interior surface of the control sleeve 20 has slightly larger circumferential dimensions than the complementary shape of the exterior surface of the body 16, so that the control sleeve 20 is movable with respect to the body 16.

In some embodiments, the shape of the exterior surface of the control sleeve 20 is substantially the same as the shape of the interior surface of the control sleeve 20. For example, the illustrated control sleeve 20 has a cylindrical exterior surface that is relatively smooth, each point on the cylindrical exterior surface having substantially the same exterior radius. In other embodiments, the shape of the exterior surface of the control sleeve 20 differs from the shape of the interior surface of the control sleeve 20. For example, the control sleeve 20 may be corrugated with ridges running parallel to the length of the body 16, or the exterior surface of the control sleeve 20 may have grooves, knurls, or other features configured to improve the ergonomics of the control sleeve 20.

In some embodiments, the exterior surface of the control sleeve 20 is free from obstructions that may interfere with the operator's hand, so that gripping the control sleeve 20 by hand is relatively comfortable. For example, the control sleeve 20 may not have flanges positioned at either a forward or a rearward end of the control sleeve 20. In such embodiments, at each point along the length of the control sleeve 20, the exterior surface of the control sleeve 20 may be substantially the same cross-sectional size and shape. In other embodiments, the control sleeve 20 may have one or more fixed flanges (not shown). For example, the flanges may include a rearward flange that encircles a rearward edge of the control sleeve 20, and a forward flange that encircles a forward edge of the control sleeve. The flanges may give the control sleeve 20 an increased thickness along the edges of the control sleeve. In some cases, the thickness of the control sleeve 20 may abruptly increase at the location of the flange, while in other cases the thickness of the control sleeve 20 may increase over a short transition area. An embodiment of a taper tool assembly 10 having fixed flanges on the control sleeve is illustrated in U.S. Pat. No. 6,209,609 to Edwards et al., which is incorporated by reference into the present disclosure.

With reference back to FIG. 1, the control sleeve 20 is operatively connected to the head 18 via the control rod 24. More specifically, the control rod 24 engages the head 18 upon sliding movement of the control sleeve 20. For example, when the control sleeve 20 is in a forward position, the control rod 24 activates the tape advancing mechanism of the head 18 to advance the tape, and when the control sleeve 20 is in a rearward position, the control rod 24 activates the tape cutting mechanism on the head 18 to cut the tape. Therefore, the function of the head 18 can be controlled by moving the control sleeve 20, which causes the control rod 24 to engage the head 18 to perform specific functions.

In some embodiments, the taper tool assembly 10 is configured to direct the movement of the control rod 24, so that the associated components of the taper tool assembly 10 are maintained in alignment. As shown in FIG. 1, a guide 34 is coupled to the body 16 between the control sleeve 20 and the head 18, and the control rod 24 extends through the guide 34. The guide 34 is a circular clamp having a channel 36 sized and shaped to receive the control rod 24, although other configurations are possible. Additionally, a control rod bracket 38 is mounted to the control sleeve 20, the control rod bracket 38 having projections 40 that extend from it and are spaced apart from each other, as shown in FIG. 3. Each projection 40 has an opening 42 that is sized and shaped to receive the control rod 24, although other configurations are possible.

With reference back to FIG. 1, the guide 34 and the control rod bracket 38 are oriented on the body 16 such that the openings 42 on the control rod bracket 38 and the channel 36 on the guide 34 are aligned along an axis substantially parallel to the axis A. The rearward end of the control rod 24 is coupled to the control rod bracket 38 on the control sleeve 20, and the forward end of the control rod 24 is coupled to the head 18, with the control rod 24 extending through the openings 42 on the control rod bracket 38 and the channel 36 on the guide 34. Once mounted, the control rod 24 is substantially parallel to the axis A. In other embodiments, however, other configurations are possible. For example, the illustrated control rod 24 is a cylindrical rod, but in other embodiments the control rod 24 may have other shapes. Further the control rod 24 may be coupled to the taper tool assembly 10 in other manners and/or the alignment of the head 18, control sleeve 20, and control rod 24 may be maintained in other manners. One or both of the guide 34 and the control rod bracket 38 may have other configurations, and one or both of the guide 34 and the control rod bracket 38 may be omitted completely.

As mentioned above, the taper tool assembly 10 further includes at least one bearing surface 44 positioned between an exterior surface of the body 16 and an interior surface of the control sleeve 20. The bearing surface 44 is configured to reduce friction between the control sleeve 20 and the body 16, facilitating the movement of the control sleeve 20 between the forward and the rearward positions. Therefore, the bearing surface 44 may be made from a material having a low coefficient of friction, such as Teflon®, or another similar polymer. So that the bearing surface 44 can be positioned between the body 16 and the control sleeve 20, the bearing surface 44 may have a thickness that is approximately equal to the difference between the interior dimension of the control sleeve 20 and the exterior dimension of the body 16. In some embodiments, the bearing surface 44 is mounted on the interior surface of the control sleeve 20, although in other embodiments the bearing surface 44 is mounted on the exterior surface of the body 16. Preferably the bearing surface 44 is a stationary, non-moving surface with respect to the surface on which it is mounted.

In some embodiments, a plurality of bearing surfaces 44 are included, in which case the bearing surfaces 44 may be oriented in sets along the length of the axis A. In the embodiment shown in FIG. 3, the bearing surfaces 44 include a forward set 46 of bearing surfaces 44 and an analogous rearward set 47 of bearing surfaces 44. The bearing surfaces 44 of the forward set 46 are aligned along a common plane that is substantially perpendicular to the axis A, such that the bearing surfaces 44 of the forward set 46 form a ring on the interior surface of the control sleeve 20. The bearing surfaces 44 of the rearward set 47 are also aligned on a plane that is substantially perpendicular to the axis A, forming a ring on the interior surface of the control sleeve 20. However, either the forward set 46 or the rearward set 47 of bearing surfaces 44 may be omitted, or additional sets of bearing surfaces 44 may be provided.

The bearing surfaces 44 may be a variety of shapes and may have a variety of orientations with reference to the axis A. As shown, each bearing surface 44 is a polygon, such as a square, oriented with forward and rearward edges of the bearing surface 44 perpendicular to the axis A. In other embodiments, the bearing surfaces 44 may be oriented to facilitate movement of drywall compound past the bearing surfaces 44. For example, the bearing surfaces 44 may be rotated so that corners of the bearing surfaces 44 point toward the forward and rearward ends of the taper tool assembly 10. The square bearing surfaces 44 shown in FIG. 3 may be rotated at a 45-degree angle to the axis A, so that corners of the square bearing surfaces 44 face the forward and rearward ends of the taper tool assembly 10. Such an orientation creates a plow effect to encourage the movement of dry wall compound along the axis A, the dry wall compound otherwise collecting between the exterior surface of the body 16 and the interior surface of the control sleeve 20 during use of the taper tool assembly 10. In other embodiments, the bearing surfaces 44 may be oval shaped with pointed ends. In such cases, the bearing surfaces may be oriented between the body 16 and the control sleeve 20 with the pointed ends facing the forward and rearward ends of the taper tool assembly 10 to produce the plowing effect described above. Further, the bearing surfaces 44 may be one or more thin strips aligned along the length of the control sleeve 20 parallel to the axis A, or aligned in rings lying in planes perpendicular to the axis A. The bearing surface 44 may even be a sheet coating the interior surface of control sleeve 20.

In embodiments in which the bearing surfaces 44 are mounted on the exterior surface of the body 16 instead of on the interior surface of the control sleeve 20, the bearing surfaces 44 may be positioned such that the bearing surfaces 44 are not exposed as the control sleeve 20 moves between the forward and rearward positions. For example, the forward set 46 and rearward set 47 of bearing surfaces 44 may be positioned closer together, inward from the forward and rearward edges of the control sleeve 20. In such embodiments, the control sleeve 20 may be inclined to tilt or pivot as the control sleeve 20 moves along the axis A, although the control rod bracket 38 and the guide 34 discussed above may assist with maintaining the alignment of the control sleeve 20 with reference to the axis A.

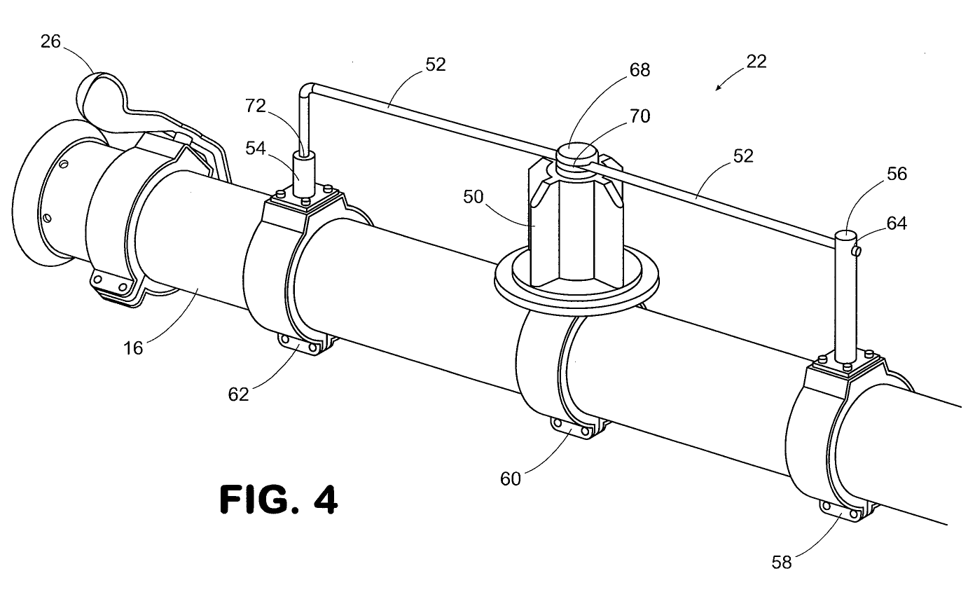

As shown in FIG. 4, the tape holding assembly 22 includes a rotating spool 50, an L-shaped retaining bar 52, a short member 54, and a tall member 56. The L-shaped retaining bar 52 is an elongated rod having a bend at a rearward end. The L-shaped retaining bar 52 is configured to hold the roll of tape in place on the rotating spool 50, while allowing the tape to rotate about the rotating spool 50. Further, the L-shaped retaining bar 52 is releasably coupled to the tape assembly 22 so that the roll of tape can be added to or removed from the rotating spool 50. More specifically, to hold the L-shaped retaining bar 52 in place, a forward end of the L-shaped retaining bar 52 fits within an aperture 64 on the tall member 56, an intermediate section of the L-shaped retaining bar 52 snap-fits into a groove 70 of the rotating spool 50, and a rearward end of the L-shaped retaining bar 52 fits within a well 72 of the short member 54.

The tall member 56 is an elongated rod having a length that is slightly longer than a width of a roll of dry wall tape. The tall member 56 is coupled to the body 16 such that an axis of the tall member 56 is substantially perpendicular to the axis A, thus forming a post. A deformable material may be used to form the tall member 56, such that a distal end of the tall member 56 (farthest from the body 16) may be deflected by applying force to the tall member 56. The aperture 64 of the tall member 56 is located at the distal end of the tall member 56 farthest from the body 16, oriented such that an axis of the aperture 64 is substantially parallel to the axis A of the taper tool assembly 10. The shape and size of the aperture 64 is complementary to and may be slightly larger than the shape and size of the forward end of the L-shaped retaining bar 52, so that the forward end of the L-shaped retaining bar 52 can be inserted into the aperture 64. Alternatively, the aperture 64 may be sized to form a pressure fitting with the L-shaped retaining bar 52 within the aperture 64.

The rotating spool 50 is a cylinder with fins, although other configurations can be used for the rotating spool 50. The knob 68 projects from a top of the rotating spool 50, and a horizontal groove 70 extends partially through the knob 68. The groove 70 is dimensioned to facilitate a snap-fit with the L-shaped retaining bar 52, and for this purpose, the knob 68 may be formed of a slightly deformable material.

The short member 54 is a rod having a length that is less than the length of the tall member 56. The short member 54 is coupled to the body 16 such that an axis of the short member 54 is substantially perpendicular to the axis A of the taper tool assembly 10. The well 72 is a bore formed at a distal end of the short member 54 farthest from the body 16, the well 72 being oriented on the short member 54 such that an axis of the well 72 is substantially parallel to the axis of the short member 54. The size and shape of the well 72 is complementary to and may be slightly larger than the size and shape of the rearward end of the L-shaped retaining bar 52, so that the rearward end can be inserted into the well 72, or the well 72 may be dimensioned to form a pressure fitting with the rearward end of the L-shaped retaining bar 52 within the well 72.

In some embodiments, three circular clamps couple the tape holding assembly 22 to the body 16, the circular clamps including a forward clamp 58, an intermediate clamp 60, and a rearward clamp 62. Each circular clamp encircles the body 16 and is secured to the body 16. The tall member 56 is mounted on the forward clamp 58, the rotating spool 50 is mounted on the intermediate clamp 60, and the short member 54 is mounted on the rearward clamp 62. The clamps are aligned on the body 16 such that the tall member 56, the rotating spool 50, and the short member 54 are axially aligned in a common plane along the axis A.

In other embodiments, the tape holding assembly 22 can have a variety of other configurations. For example, the tape holding assembly 22 may be oriented differently on the body 16, such as in embodiments in which the short member 54 is positioned forward of the rotating spool 50 and the tall member 56 is positioned rearward of the rotating spool 50.

The taper tool assembly 10 may also be configured to press the compound-laden tape into a corner. As shown in FIG. 4, the trigger mechanism 26 is located rearward of the tape holding assembly 22. The trigger mechanism 26 is operatively coupled to a pivot arm 32 on the head 18, and the pivot arm 32 is coupled to a disc 30, shown in FIG. 3. In response to movement of the trigger mechanism 26, the pivot arm 32 is configured to rotate about an axis perpendicular to the axis A of the taper tool assembly 10, rotating the disc 30 into position to press the tape into a corner.

The operation of the taper tool assembly 10 will now be described. The taper tool assembly 10 is prepared for use. The hollow portion of the body 16 of the taper tool assembly 10 is filled with dry wall compound, and a roll of dry wall tape is loaded into the tape holding assembly 22.

To load the roll of dry wall tape, the forward end of the L-shaped retaining bar 52 is removed from the aperture 64 on the tall member 56, such as by deflecting the tall member 56 and/or the L-shaped retaining bar 52, and the intermediate section of the L-shaped retaining bar 52 is removed from the groove 70 in the knob 64, such as by snapping the intermediate section out of the groove 70. The L-shaped retaining bar 52 is rotated away from the body 16, such as by rotating the L-shaped retaining bar 52 about the rearward end within the well 72 of the short member 54. The roll of dry wall tape is then placed on the rotating spool 50, and the L-shaped retaining bar 52 is rotated toward the body 16 and put back into place, the intermediate section being snap-fitted into the groove 70 on the knob 68, and the forward end of the L-shaped retaining bar 52 being positioned in the aperture 64 of the tall member 56. The taper tool assembly 10 is then ready for use. It will be noted that, in the illustrated embodiment, the L-shaped retaining bar 52 rotates away from the body 16 within a plane defined by the roll of dry wall tape.

The taper tool assembly 10 is operated using the control sleeve 20. Initially, the control sleeve 20 is in the neutral position. The control sleeve 20 is moved forward to advance the tape forward, so that the tape is positioned below the nozzle and dry wall compound can be ejected from the nozzle onto the tape. More specifically, moving the control sleeve 20 forward from the neutral position engages the control rod 24 to move forward, which causes a pin on the tape advancing mechanism to engage the tape. As the control sleeve 20 continues moving from the neutral to the forward position, the pin advances the tape forward so that the tape is positioned below the nozzle.

Once the tape is positioned below the nozzle, the control sleeve 20 is reciprocated rearward to the neutral position, which causes the control rod 24 to move rearward, disengaging the pin of the tape advancing mechanism from the tape. Thus, the control sleeve 20 is returned to the neutral position without moving the tape rearward.

Rotating the wheels 28 simultaneously advances tape from the tape holding assembly 22 and ejects dry wall compound from the nozzle onto the tape. The head 18 feeds the compound-laden tape over the wheels 28, the wheels 28 are placed in contact with the dry wall sheets straddling the exposed joint, and as the wheels 28 rotate over the dry wall, the wheels 28 apply the compound-layered tape to the exposed dry wall joint. In this manner, dry wall compound and dry wall tape are applied to the joint by merely rolling the wheels 28 of the taper tool assembly 10 along the exposed joint. Further, rolling the wheels 28 of the taper tool assembly 10 along the joint simultaneously prepares the tape to be applied to the joint by applying dry wall compound to the tape.

When the end of the joint is reached, the tape is cut by sliding the control sleeve 20 into the rearward position, which reciprocates the control rod 24 rearward to engage the tape cutting mechanism on the head 18. The blade of the tape cutting mechanism then cuts the tape. The control sleeve 20 is then reciprocated forward to the neutral position.

After the tape is cut, the tape may not be positioned under the nozzle, because the blade of the tape cutting mechanism may be rearward of the nozzle. Therefore, it may be desirable to advance the tape without ejecting dry wall compound from the nozzle, so that the tape is positioned under the nozzle when dry wall compound is ejected from the nozzle. This may be accomplished by reciprocating the control sleeve 20 into the forward position, which advances the tape without simultaneously ejecting dry wall compound from the nozzle so that the tape is positioned under the nozzle when the wheels 28 are next rotated.

The trigger mechanism 26 is engaged to rotate the pivot arm 32 on the head 18, which causes the disc 30 to rotate forward. With the disc 30 in the forward position, the taper tool assembly 10 may be used to apply dry wall compound and tape to a corner. The wheels 28 are rotated to feed compound-laden tape over the wheels 28, as described above, and the disc 30 contacts the tape to press the tape into the corner. Once the corner joint has been completed, the control sleeve 20 is reciprocated rearward to cut the tape, as described above. The trigger mechanism 26 is then engaged to rotate the pivot arm 32 rearward, which causes the disc 30 to rotate rearward so that the taper tool assembly 10 is oriented for use with non-corner joints. The control sleeve 20 may be reciprocated forward to activate the tape advancing mechanism on the head 18, such that the tape may be advanced forward without ejecting dry wall compound from the nozzle. The taper tool assembly 10 is then ready to be used on the next joint.

Therefore, the taper tool assembly 10 is controlled by sliding the control sleeve 20 rearward or forward along the body 16. For example, the control sleeve 20 is moved forward to advance the tape without ejecting dry wall compound from the nozzle, and is moved rearward to cut the tape. The bearing surfaces 44 between the body 16 and the control sleeve 20 reduce the friction between the body 16 and the control sleeve 20, reducing wear between the control sleeve 20 and the body 16.

While particular embodiments of a taper tool assembly have been disclosed in detail in the foregoing description and figures for purposes of example, those skilled in the art will understand that variations and modifications may be made without departing from the scope of the disclosure. All such variations and modifications are intended to be included within the scope of the present disclosure, as protected by the following claims.

At least the following is claimed:

1. A taper tool assembly comprising:
a body configured to hold dry wall compound;
a control sleeve configured to move along at least a portion of a length of the body; and
at least one bearing surface positioned between the body and the control sleeve, the at least one bearing surface reducing friction between the body and the control sleeve.

2. The taper tool assembly of claim 1, wherein the at least one bearing surface is coupled to an interior surface of the control sleeve.

3. The taper tool assembly of claim 1, wherein the at least one bearing surface is coupled to an exterior surface of the body.

4. The taper tool assembly of claim 1, wherein the at least one bearing surface is made from a material having a relatively low coefficient of friction, such that wear between the control sleeve and the body is reduced.

5. The taper tool assembly of claim 1, wherein the at least one bearing surface includes a plurality of bearing surfaces arranged in sets, a forward set of bearing surfaces being coupled to an interior surface of the control sleeve adjacent a forward edge of the control sleeve, and a rearward set of bearing surfaces being coupled to the interior surface of the control sleeve adjacent a rearward edge of the control sleeve.

6. The taper tool assembly of claim 1, wherein the control sleeve substantially surrounds a portion of the body, the control sleeve having an interior surface that is shaped to complement an exterior surface of the body, the at least one bearing surface being positioned in contact with the interior surface of the control sleeve and the exterior surface of the body.

7. The taper tool assembly of claim 1, wherein at each point along a length of the control sleeve, an exterior surface of the control sleeve is substantially the same cross-sectional size and shape.

8. A control sleeve configured to be moved along a body of a taper tool to control a head of the taper tool, the control sleeve comprising:
an interior surface shaped to complement an exterior surface of the body, the interior surface surrounding a portion of the body; and
at least one bearing surface coupled to the interior surface, the at least one bearing surface being configured to reduce friction between the interior surface of the control sleeve and the exterior surface of the body as the control sleeve moves along the body.

9. The control sleeve of claim 8, wherein the at least one bearing surface is made from a material having a relatively low coefficient of friction, such that wear between the control sleeve and the body is reduced.

10. The control sleeve of claim 8, wherein the at least one bearing surface includes a plurality of bearing surfaces arranged in sets, the sets include a forward set of bearing surfaces positioned adjacent a forward edge of the control sleeve, and a rearward set of bearing surfaces positioned adjacent a rearward edge of the control sleeve.

11. The control sleeve of claim 8, wherein the control sleeve further comprises an exterior surface, and at each point along a length of the control sleeve, the exterior surface is substantially the same cross-sectional size and shape.

12. A taper tool assembly comprising:
a body configured to hold dry wall compound;
a tape assembly configured to hold a roll of dry wall tape;
a head configured to eject compound from the body onto tape supplied by the tape assembly;
a control sleeve configured to be moved forward and rearward to control the head; and
at least one bearing surface positioned between the body and the control sleeve, the at least one bearing surface reducing friction between the body and the control sleeve.

13. The taper tool assembly of claim 12, wherein the at least one bearing surface is coupled to an interior surface of the control sleeve.

14. The taper tool assembly of claim 12, wherein the at least one bearing surface is coupled to an exterior surface of the body.

15. The taper tool assembly of claim 12, wherein the at least one bearing surface is made from a material having a relatively low coefficient of friction, such that wear between the control sleeve and the body is reduced.

16. The taper tool assembly of claim 12, wherein the at least one bearing surface includes a plurality of bearing surfaces arranged in sets, a forward set of bearing surfaces being coupled to an interior surface of the control sleeve adjacent a forward edge of the control sleeve, and a rearward set of bearing surfaces being coupled to the interior surface of the control sleeve adjacent a rearward edge of the control sleeve.

17. The taper tool assembly of claim 12, wherein the control sleeve substantially surrounds a portion of the body, the control sleeve including:
an interior surface that is shaped to complement an exterior surface of the body, the at least one bearing surface being positioned in contact with the interior surface of the control sleeve and the exterior surface of the body, and
an exterior surface that is substantially the same cross-sectional size and shape at each point along a length of the control sleeve.

18. The taper tool assembly of claim 12, wherein the tape assembly comprises:
an L-shaped retaining bar;
a tall member having an aperture, the aperture being configured to releasably hold a first end of the L-shaped retaining bar;
a rotating spool configured to hold a roll of dry wall tape, the rotating spool having a groove that is configured to releasably hold an intermediate section of the L-shaped retaining bar; and
a short member having a well, a second end of the L-shaped retaining bar being positioned in the well, the second end being able to rotate within the well,
such that the roll of tape can be coupled to the tape holding assembly by removing the first end from the aperture, removing the intermediate section from the groove, rotating the L-shaped retaining bar about the second end in the well, placing the roll of dry wall tape on the rotating spool, rotating the L-shaped retaining bar back into place, positioning the intermediate section in the groove, and positioning the first end in the aperture.

19. The taper tool assembly of claim 18, wherein the groove is configured to form a snap-fitting with the intermediate section of the L-shaped retaining bar.

20. The taper tool assembly of claim 18, wherein the tall member is made from a deformable material, such that the tall member can be deflected away from the L-shaped retaining bar to remove the first end of the L-shaped retaining bar from the opening.
